(19) United States
(12) Patent Application Publication
(10) Pub. No.: US 2014/0269818 A1
(43) Pub. Date: Sep. 18, 2014

(54) Heat Flow Measurement Device And Method

(71) Applicants: Eric Henry Baller, Webster, NY (US); David Martyn Neale, Pittsford, NY (US)

(72) Inventors: Eric Henry Baller, Webster, NY (US); David Martyn Neale, Pittsford, NY (US)

(21) Appl. No.: 13/802,107

(22) Filed: Mar. 13, 2013

(51) Int. Cl. G01K 17/00

(52) U.S. Cl. CPC G01K 17/00
USPC 374/29

(57) ABSTRACT

A heat flow measurement device is disclosed with an outflow conduit having an outflow fluid space and an outflow heat transfer surface and also with an inflow conduit having an inflow fluid space and an inflow heat transfer surface. The inflow heat transfer surface is thermally coupled to the inflow conduit and the outflow heat transfer surface is thermally coupled to the outflow conduit. A thermoelectric material is located between the inflow heat transfer surface and the outflow heat transfer surface and generates a signal that is proportional to the heat flux between the inflow conduit and the outflow conduit.

### BACKGROUND OF THE INVENTION

1. Field of the Invention

This invention relates generally to instrumentation and measurement, and more specifically to a Heat Flow Measurement Device and method that measures heat flow without the necessity of measuring fluid flow.

2. Description of Related Art

Methods and systems to measure transferred heat, for example to a heat exchanger, primarily use an indirect approach where volume flow of a fluid is measured along with some other parameter such as the difference in temperature between the incoming and outgoing fluid streams. Calculations are then performed using these measured values. Many flow meters measure velocity of a fluid but do not always take into consideration the change in heat capacity of a fluid that contains mixed components such as water and glycol in a geothermal or solar thermal system. While some flow meters use mass flow as their baseline, heat calculations still require collection and processing of a set of parameters. Additionally, there are flow meters that add a small amount of heat to a device and measure the change in temperature of the fluid, but the measurement of flow is still required to determine transferred heat or heat flow.

What is needed is a Heat Flow Measurement Device that measures heat flow directly without the need for measuring fluid flow and thermal properties of the fluid, thus alleviating the need for two measurements and related calculations, therefore simplifying the measurement of heat flow in a system.

It is thus an object of the present invention to provide a Heat Flow Measurement Device that measures heat flow without the necessity of measuring fluid flow. It is another object of the present invention to provide a Heat Flow Measurement Device that has fewer parts and is more reliable than previous heat flow measuring devices. It is another object of the present invention to provide a method of calculating heat flow directly, without the need for flow measurements of the fluid, determination of thermal properties of the fluid, and related calculations.

These and other objects of the present invention are not to be considered comprehensive or exhaustive, but rather, exemplary of objects that may be ascertained after reading this specification and claims with the accompanying drawings.

### BRIEF SUMMARY OF THE INVENTION

In accordance with the present invention, there is provided a Heat Flow Measurement Device comprising an outflow conduit having a first outflow conduit fitting and a second outflow conduit fitting; an outflow fluid space within the outflow conduit; an inflow conduit having a first inflow conduit fitting and a second inflow conduit fitting; an inflow fluid space within the inflow conduit; an inflow heat transfer surface comprising a surface of the inflow conduit; an outflow heat transfer surface comprising a surface of the outflow conduit; a thermoelectric material located between the inflow heat transfer surface and the outflow heat transfer surface; an inflow ohmic connection ohmically connected to the inflow heat transfer surface; and an outflow ohmic connection ohmically connected to the outflow heat transfer surface.

The foregoing paragraph has been provided by way of introduction, and is not intended to limit the scope of the invention as described in this specification, claims and the attached drawings.

### BRIEF DESCRIPTION OF THE DRAWINGS

The invention will be described by reference to the following drawings, in which like numerals refer to like elements, and in which:

FIG. 1 is a perspective view of a Heat Flow Measurement Device according to one embodiment of the present invention:

FIG. 2 is a top plan view of the Heat Flow Measurement Device of FIG. 1;

FIG. 3 is a perspective view of the Heat Flow Measurement Device of FIG. 1 with an exemplary insulation structure;

FIG. 4 is a top plan view of the Heat Flow Measurement Device of FIG. 3;

FIG. 5 is a side plan view of the Heat Flow Measurement Device of FIG. 3;

FIG. 6 is a cutaway view of one embodiment of the Heat Flow Measurement Device cut along line A-A of FIG. 2;

FIG. 7 is a cutaway view of the Heat Flow Measurement Device cut along line B-B of FIG. 2;

FIG. 8 is a cutaway view of the Heat Flow Measurement Device cut along line C-C of FIG. 5;

FIG. 9 is a cutaway view of another embodiment of the Heat Flow Measurement Device cut along line A-A of FIG. 2;

FIG. 10 is a cutaway view of another embodiment of the Heat Flow Measurement Device having a rectangular profile;

FIG. 11 is a cutaway view of another embodiment of the Heat Flow Measurement Device having a triangular profile:

FIG. 12 shows the structure of the thermoelectric material and heat transfer surfaces;

FIG. 13 is an exemplary graph of incident flux vs. output voltage for a typical thermoelectric material used with the Heat Flow Measurement Device; and

FIG. 14 is an exemplary block circuit diagram of the Heat Flow Measurement Device of the present invention in use.

The attached figures depict various views of the Heat Flow Measurement Device in sufficient detail to allow one skilled in the art to make and use the present invention. These figures are exemplary, and depict a preferred embodiment; however, it will be understood that there is no intent to limit the invention to the embodiment depicted herein. On the contrary, the intent is to cover all alternatives, modifications, and equivalents as may be included within the spirit and scope of the invention as defined by this specification, claims and drawings.

### DESCRIPTION OF THE PREFERRED EMBODIMENTS

A Heat Flow Measurement Device and related method is described and depicted by way of this specification and the attached drawings. For a general understanding of the present invention, reference is made to the drawings. In the drawings, like reference numerals have been used throughout to designate identical elements.

To provide a complete understanding of the present invention and the various embodiments that may be described or envisioned herein, a review of the fundamental thermodynamic principles used in describing the present invention are in order.

Heat is a form of energy, commonly measured in Joules but also in kilowatt hours (Kwh), Calories, and British Thermal Units (BTUs). The generally known relation for measuring heat energy Q is:

Q=m·Cₚ·ΔT

Where: Q is the measured heat energy; m is the mass of the medium; Cₚ is the specific heat of the medium; and ΔT is the temperature difference across the thermal exchange. For illustration, 1 kilocalorie of heat energy is required to raise the temperature of 1 kilogram of water by 1 degree C. The specific heat of pure water is 1.

To measure the heat energy consumed by an unknown load (for example, in the case of a home heating load) or produced by an unknown source (for example, in the case of a water heater), the present invention takes advantage of the consistency of the medium, combined with an innovative use of temperature sensors, known heat transfer mediums and the Seebeck effect.

The heat flow across an unknown load L, Q_{L} is given by:

Q_{L}=m·Cₚ·ΔT.

or

Q_{L}/ΔT_{L}=m·Cₚ (1)
where ΔT=T3−T2 and ΔT_{M}=T1−T2

We do not know the mass flow rate m or heat capacity C_{P} of the particular medium—it could be for example a liquid, a gas or a powdery medium. Examples include water or a mixture of water and anti-freeze of an unknown concentration. As used herein, the term fluid includes liquids, gases, plasmas, plastic solids, powdery or granular materials, and any substance that deforms or flows under an applied stress.

As shown in FIGS. 1 and 8, the present invention provides an additional, parallel heat flow Q_{M} to the unknown load Q_{L}. It should further be noted that QL may be a load or a source.

The present invention provides a thermal conduit through the load and a structure that forces the heat energy through a measuring device. The measuring device in the preferred embodiment takes advantage of the Seebeck effect to produce a voltage that is proportional to the heat flow.

The first law of thermodynamics, the conservation of energy, states that the heat lost by one part of a closed system is gained by another. Thus, the heat lost to the parallel flow. Q_{M}, is lost to the flow of the medium in FIGS. 1 and 8 and the effect in the medium is:

Q_{M}·m·Cₚ·ΔT_{M}

or

Q_{M}/ΔT_{M}=m·Cₚ (2)

Where: Q_{M} is the measured heat energy: m is the mass flow rate; Cₚ is the heat capacity of the medium; and ΔT_{M} is the temperature difference across the thermal exchange to the parallel load.

The sensitivity, resolution and operating range of the heat meter will depend on the choice of material and dimensions.

Since the same medium flows through the pipe at both points, the m and C_{P} of the medium are constant. Thus, the (m·Cₚ) terms of equation (1) and (2) are equal, leading to:

Q_{L}/ΔT_{L}=Q_{M}/ΔT_{M}

or

Q_{L}=Q_{M}−ΔT_{L}/ΔT_{M} (3)

The quantities of Q_{M}, ΔT_{L}, and ΔT_{M} being measured by the present invention, enables a calculation of Q_{L} using a method of the present invention.

In support of the above formulas, FIG. 1 depicts Q_{L} and Q_{M}. In addition, T1, T2, T3 and T4 are depicted in FIG. 1 where ΔT_{L}=T3−T2 and ΔT_{M}=T1−T2. In some embodiments of the present invention, T4 may be used to improve accuracy or to support alternative fluid flows or the like. In some embodiments of the present invention, T4 may be used to measure cooling, negative or reverse heat flow, and the like.

Where only relative heat flow is needed, a measurement of Q_{M} may be sufficient without the need for ΔT_{L} or ΔT_{M}. For example, district heating or other multiple source applications. Many applications do not require an absolute heat flow value, but only a relative value for comparison against other relative or absolute values.

Turning now to the drawings. FIG. 1 is a perspective view of a Heat Flow Measurement Device 100 according to one embodiment of the present invention. It should be noted that the geometry depicted in the drawings is exemplary, and not to be taken in any way as a limitation. Rather, various and assorted geometries may be considered and employed that are dictated or otherwise suggested by a myriad of factors such as cost, application, and the like, and are to be inclusively considered as various embodiments of the present invention. The exemplary Heat Flow Measurement Device 100 depicted in FIG. 1 does not include an insulation envelope, which also may be included as an embodiment of the present invention. Such an insulation envelope is depicted by way of example in FIG. 3. The Heat Flow Measurement Device 100 depicted in FIG. 1 will also be depicted in subsequent drawings, and comprises an outflow conduit 101 and an inflow conduit 107 whereas the inflow conduit 107 generally encompasses or is coaxial to the outflow conduit 101, or in the alternative, the outflow conduit 101 encompasses or is coaxial to the inflow conduit 107. Such an arrangement allows for thermoelectric material to be placed between or adjacent to the two fluid flow conduits or spaces. In an alternative embodiment, the inflow conduit 107 and the outflow conduit 101 are located proximate each other with a thermoelectric material there between.

The outflow conduit 101 and the inflow conduit 107 are made from a material capable of containing a fluid or a gas, such as, for example, a metal such as brass, stainless steel, iron, or the like. Various plastics may also be suitable, such as polyvinyl chloride (PVC), polypropylene (PP), polyethylene (PE), acrylonitrile butadiene styrene (ABS), polyvinylidene fluoride (PVDF), and the like. For plastic components, reinforcing materials may be added in some embodiments of the present invention. Fabrication of the outflow conduit 101, the inflow conduit 107, and related parts may employ casting, stamping, machining, extruding, injection molding, or the like. The outflow conduit 101 has a first outflow conduit fitting 103 and a second outflow conduit fitting 105 to facilitate connection to a fluid or gas distribution system. The fittings may be threaded, quick release, solder joint, compression, or the like.

Similar to the outflow conduit, the inflow conduit 107 has a first inflow conduit fitting 109 and a second inflow conduit fitting 111 to facilitate connection to a fluid or gas distribution system. The inflow conduit 107 may, in some embodiments of the present invention, be a generally cylindrical body with a first inflow conduit fitting 109 having a generally right angle bend and a second inflow conduit fitting 111 having a generally right angle bend. In some embodiments of the present invention, the inflow conduit body may be of a larger diameter than the first inflow conduit fitting 109 and the second inflow conduit fitting 111. The first inflow conduit fitting 109 and the second inflow conduit fitting 111 may be threaded, quick release, solder joint, compression, or the like. The outflow conduit 101 and the inflow conduit 107 are sealed at points where they meet such that the fluid flow through the inflow conduit 107 is contained therewithin, and the fluid flow through the outflow conduit 101 is also contained therewithin. Such seals may be made from a material that is the same or similar to the inflow conduit 107 and the outflow conduit 101, or the seals may be made from a conformal material such as rubber, silicone, cork, felt, synthetic cloth, soft metal, or the like.

As will be further described, a thermoelectric material is contained in a space between the outflow conduit 101 and the inflow conduit 107 and an electrical or ohmic connection is made to each side of the thermoelectric material in such a way as to provide a voltage or a current output that is proportional to the heat flux through the thermoelectric material. The electrical or ohmic connection to each side may be made by a conductive material that may, in some embodiments of the present invention, be in electrical contact with, or be made from, a wall or part of the outflow conduit 101 and or the inflow conduit 107 and may then be terminated to an inflow ohmic connection 115 and an outflow ohmic connection 117 and to wires or other conductors and an electrical connector 113 or similar conductively mating structure. The output from the electrical connector is a voltage or a current that is proportional to Q_{M}, the measured heat energy.

FIG. 2 is a top plan view of the Heat Flow Measurement Device 100 of FIG. 1 that shows the exemplary geometries depicted in FIG. 1. The Heat Flow Measurement Device 100 may also, in some embodiments of the present invention, be encapsulated by or otherwise surrounded or covered by an insulation structure 301 such as that depicted in FIG. 3. The insulation structure may be made from fiberglass, a rigid foam such as phenolic, polyethylene, closed cell rubbers such as nitrile rubber, nitrile butadiene rubber, is mineral wool, and the like. The insulation structure 301 may take on various forms and may cover a part of the Heat Flow Measurement Device 100 or the entire device 100. FIG. 4 is a top plan view of the Heat Flow Measurement Device of FIG. 3 showing an example of an insulation structure 301. FIG. 5 is a side plan view of the Heat Flow Measurement Device of FIG. 3.

Turning now to FIG. 6, a cutaway view of one embodiment of the Heat Flow Measurement Device 100 cut along line A-A of FIG. 2 can be seen. The outflow conduit 101 can be seen within the inflow conduit 107 forming an inflow fluid space 603. An outflow fluid space 601 can also be seen within the outflow conduit 101. An inflow heat transfer surface 605 can also be seen adjacent to, and a making up an outer boundary of, the inflow fluid space 603. The inflow fluid contained within the inflow fluid space 603 is in thermal communication with the inflow heat transfer surface 605 and is thermally coupled to the thermoelectric material 607. On the opposing side of the thermoelectric material 607 is an outflow heat transfer surface comprising an outer boundary of the outflow fluid space 601. The outflow heat transfer surface, in one embodiment of the present invention, comprises the outflow conduit 101 or a portion thereof.

The thermoelectric material 607 responds to temperature differences between one side of the thermoelectric material 607 and the other side. The thermoelectric material 607 may, in one embodiment of the present invention, be a Seebeck effect material or structure. The thermoelectric material 607 may, in some embodiments of the present invention, comprise a Peltier junction or Peltier effect material or structure. An example of a thermoelectric material is the MICRO-FOIL® heat flow sensor by RdF Corporation, 23 Elm Avenue, Hudson, N.H. This sensor is a differential thermocouple type sensor which utilizes a thin foil type thermopile bonded to both sides of a known thermal barrier. A temperature difference across the thermal barrier of the sensor is proportional to heat flux through the sensor. The thermoelectric material 607 may in fact be two thermoelectric materials creating a junction by which a voltage difference develops in response to a heat flux through the material. Examples of suitable materials include, for example, ALUMEL® and CIHROMEL® from Hoskins Manufacturing Company, both alloys. ALUMEL® being approximately 95% nickel, 2% manganese, 2% aluminum, and 1% silicon. CHROMEL® being approximately 90% nickel and 10% chromium. The junctions may be stacked in series to increase resolution. Another suitable thermoelectric material 607 is a ceramic-plastic composite sensor manufactured by Hukseflux Sensors, Inc., Manorville, N.Y., USA such as their HFP03 sensor which is a thermopile that responds due to the differential temperature across the ceramics-plastic composite body of the HFP03 sensor and generates a small output voltage that is proportional to heat flux. Another suitable sensor is the MF series of heat flow sensors manufactured by Eko Instruments Company, Ltd. of Tokyo, Japan. The MF series sensors from Eko Instruments Company, Ltd. use a glass epoxy resin that is thermally stable for the substrate, the thermal resistive element. A thermopile structure is then arranged on the substrate with a cladding on top. Other material configurations and sensor topologies may also be suitable for the thermoelectric material 607.

In some embodiments of the present invention, flow vanes may be added to the outflow fluid space 601 to provide more uniform thermal characteristics for measurement. In FIG. 6 a first flow vane 609, a second flow vane 611 and a third flow vane 613 can be seen. In this example, there are five flow vanes, where a fourth flow vane 701 and a fifth flow vane 703 can be seen in FIG. 7. There may, in some embodiments of the present invention, be more or less than five flow vanes. In some embodiments of the present invention, the flow vanes are generally parallel with the axis of the outflow conduit 101 and may travel the entire length of the outflow conduit 101 or a portion thereof. The flow vanes may be made from a metal such as brass, aluminum, stainless steel, or the like, or may be made from a plastic such as polyvinyl chloride (PVC), polypropylene (PP), polyethylene (PE), acrylonitrile butadiene styrene (ABS), polyvinylidene fluoride (PVDF), and the like. FIG. 7 is a cutaway view of the Heat Flow Measurement Device cut along line B-B of FIG. 2 that shows an example of a five flow vane configuration.

FIG. 8 is a cutaway view of the Heat Flow Measurement Device cut along line C-C of FIG. 5 that clearly shows the inner workings of the Heat Flow Measurement Device 100 which comprises an outflow conduit 101 having a first outflow conduit fitting 103 and a second outflow conduit fitting 105, an outflow fluid space 601 (see also FIG. 6) within the outflow conduit 101, an inflow conduit 107 having a first inflow conduit fitting 109 and a second inflow conduit fitting 111, the inflow conduit 107 generally encompassing the outflow conduit 101 and an inflow fluid space 603 created by the spacing between the inflow conduit 107 and the outflow conduit 101, an inflow heat transfer surface 605 comprising a surface of the inflow conduit 107 and an outflow heat transfer surface 101 comprising a surface of the outflow conduit 101, a thermoelectric material 607 located between the inflow heat transfer surface 605 and the outflow heat transfer surface 101, an inflow ohmic connection 115 (see also FIG. 6) ohmically connected to the inflow heat transfer surface 605, and an outflow ohmic connection 117 (see also FIG. 6) ohmically connected to the outflow heat transfer surface 101.

FIG. 9 is a cutaway view of another embodiment of the Heat Flow Measurement Device cut along line A-A of FIG. 2. To improve proper measurement in some applications, the Heat Flow Measurement Device 100 may also comprise bumps or raised features or generally a textured surface 901 within the outflow fluid space. The textured surface 901 may be embossed, stamped, cast, molded or otherwise formed on the interior surface of the outflow fluid space. In some embodiments of the present invention, the textured surface 901 may be added to the interior surface of the outflow fluid space by an adhesive, a spray, a coating, or the like. In a similar manner, the inflow fluid space may also comprise bumps, raised features or a generally textured surface that may be embossed, stamped, cast, molded or otherwise formed on the interior surface of the inflow fluid space. In some embodiments of the present invention, the textured surface may be added to the interior surface of the inflow fluid space by an adhesive, a spray, a coating, or the like.

Various geometries may be employed in the heat flow measurement device. For example, FIG. 10 is a cutaway view of another embodiment of the Heat Flow Measurement Device having a rectangular profile. An inflow fluid space 1003 formed by an inflow conduit and an outflow fluid space 1011 formed by an outflow conduit can be seen with a rectangular profile. The inflow fluid space 1003 is confined by an inflow wall 1001 and an inflow heat transfer surface 1005. The outflow fluid space 1011 is confined by an outflow heat transfer surface 1009 and the outflow fluid space 1011 is surrounded by or otherwise encompassed by the inflow fluid space 1003. In some embodiments of the present invention, the outflow fluid space 1011 and the inflow fluid space 1003 are interchanged. A thermoelectric material 1007 is depicted between the inflow heat transfer surface 1005 and the outflow heat transfer surface 1009. The thermoelectric material 1007 responds to temperature differences between one side of the thermoelectric material 1007 and the other side. The thermoelectric material 1007 may, in one embodiment of the present invention, be a Seebeck effect material or structure. The thermoelectric material 1007 may, in some embodiments of the present invention, comprise a Peltier junction or Peltier effect material or structure. An example of a thermoelectric material is the MICRO-FOIL® heat flow sensor by RdF Corporation. 23 Elm Avenue, Hudson, N.H. This sensor is a differential thermocouple type sensor which utilizes a thin foil type thermopile bonded to both sides of a known thermal barrier. A temperature difference across the thermal barrier of the sensor is proportional to heat flux through the sensor as measured by an output voltage. The thermoelectric material 1007 may in fact be two thermoelectric materials creating a junction by which a voltage difference develops in response to heat flux through the material. Examples of suitable materials include, for example, ALUMEL® and CHROMEL® from Hoskins Manufacturing Company, both alloys. ALUMEL® being approximately 95% nickel, 2% manganese, 2% aluminum, and 1% silicon. CHROMEL® being approximately 90% nickel and 10% chromium. The junctions may be stacked in series to increase resolution. Another suitable thermoelectric material 1007 is a ceramic-plastic composite sensor manufactured by Hukseflux Sensors, Inc., Manorville, N.Y., USA such as their HFP03 sensor which is a thermopile that measures the differential temperature across the ceramics-plastic composite body of the HFP03 sensor and generates a small output voltage that is proportional to heat flux. Another suitable sensor is the MF series of heat flow sensors manufactured by Eko Instruments Company, Ltd. of Tokyo, Japan. The MF series sensors from Eko Instruments Company, Ltd. use a glass epoxy resin that is thermally stable for the substrate, the thermal resistive element. A thermopile structure is then arranged on the substrate with a cladding on top. Other material configurations and sensor topologies may also be suitable for the thermoelectric material 1007.

The outflow conduit and the inflow conduit that comprise the outflow fluid space 1011 and the inflow fluid space 1003 respectively are made from a material capable of containing a fluid or a gas, such as, for example, a metal such as brass, stainless steel, iron, or the like. Various plastics may also be suitable, such as polyvinyl chloride (PVC), polypropylene (PP), polyethylene (PE), acrylonitrile butadiene styrene (ABS), polyvinylidene fluoride (PVDF), and the like. For plastic components, reinforcing materials may be added in some embodiments of the present invention. Fabrication of the outflow conduit, the inflow conduit, and related parts may employ casting, stamping, machining, extruding, injection molding, or the like.

FIG. 11 is a cutaway view of another embodiment of the Heat Flow Measurement Device having a triangular profile. An inflow fluid space 1103 formed by an inflow conduit and an outflow fluid space 1111 formed by an outflow conduit can be seen with a triangular profile. The inflow fluid space 1103 is confined by an inflow wall 1101 and an inflow heat transfer surface 1105. The outflow fluid space 1111 is confined by an outflow heat transfer surface 1109 and the outflow fluid space 1111 is surrounded by, encompassed by or otherwise adjacent to the inflow fluid space 1103. In some embodiments of the present invention, the outflow fluid space 1111 and the inflow fluid space 1103 are interchanged. A thermoelectric material 1107 is depicted between the inflow heat transfer surface 1105 and the outflow heat transfer surface 1109. The thermoelectric material 1107 responds to temperature differences between one side of the thermoelectric material 1107 and the other side. An example of a thermoelectric material is the MICRO-FOIL® heat flow sensor by RdF Corporation. 23 Elm Avenue, Hudson, N.H. This sensor is a differential thermocouple type sensor which utilizes a thin foil type thermopile bonded to both sides of a known thermal barrier. A temperature difference across the thermal barrier of the sensor is proportional to heat flux through the sensor. The thermoelectric material 1107 may in fact be two thermoelectric materials creating a junction by which a voltage difference develops in response to heat flux through the material. Examples of suitable materials include, for example, ALUMEL® and CHROMEL® from Hoskins Manufacturing Company, both alloys. ALUMEL® being approximately 95% nickel, 2% manganese, 2% aluminum, and 1% silicon. CHROMEL® being approximately 90% nickel and 10% chromium. The junctions may be stacked in series to increase resolution. Another suitable thermoelectric material 1107 is a ceramic-plastic composite sensor manufactured by Hukseflux Sensors, Inc., Manorville, N.Y., USA such as their HFP03 sensor which is a thermopile that measures the differential temperature across the ceramics-plastic composite body of the HFP03 sensor and generates a small output voltage that is proportional to heat flux. Another suitable sensor is the MF series of heat flow sensors manufactured by Eko Instruments Company. Ltd. of Tokyo, Japan. The MF series sensors from Eko instruments Company, Ltd. use a glass epoxy resin that is thermally stable for the substrate, the thermal resistive element. A thermopile structure is then arranged on the substrate with a cladding on top. Other material configurations and sensor topologies may also be suitable for the thermoelectric material 1107.

The outflow conduit and the inflow conduit that comprise the outflow fluid space 1111 and the inflow fluid space 1103 respectively are made from a material capable of containing a fluid or a gas, such as, for example, a metal such as brass, stainless steel, iron, or the like. Various plastics may also be suitable, such as polyvinyl chloride (PVC), polypropylene (PP), polyethylene (PE), acrylonitrile butadiene styrene (ABS), polyvinylidene fluoride (PVDF), and the like. For plastic components, reinforcing materials may be added in some embodiments of the present invention. Fabrication of the outflow conduit, the inflow conduit, and related parts may employ casting, stamping, machining, extruding, injection molding, or the like.

FIG. 12 shows the structure of the thermoelectric material and heat transfer surfaces where a first heat transfer surface 1201 and a second heat transfer surface 1205 can be seen with a thermoelectric material 1203 therebetween. The thermoelectric material having been heretofore described and depicted in various embodiments of the Heat Flow Measurement Device.

FIG. 13 is an exemplary graph of incident flux vs. output voltage for a typical thermoelectric material used with the Heat Flow Measurement Device. It should be noted that for some thermoelectric materials, the output may be in microvolts as opposed to millivolts. Further, it should be noted that while the graph of FIG. 13 is depicted as linear, the output of many thermoelectric materials is linear for only a finite and limited temperature range. Therefore, temperature compensation techniques may be necessary should the Heat Flow Measurement Device be used in a wide range of temperatures. Such temperature compensation techniques may include, for example, measurement of operational temperature of the thermoelectric material and using the operational temperature as a defining variable to determine the incident flux.

Lastly, FIG. 14 is an exemplary block circuit diagram of the Heat Flow Measurement Device of the present invention in use. For simplicity, a single heat source 1401 and related Heat Flow Measurement Device 1403 are depicted.

A method of calculating heat flow using the Heat Flow Measurement Device of the present invention comprises the steps of creating a fluid flow having a first temperature in the outflow conduit of the Heat Flow Measurement Device, creating a fluid flow having a second temperature in the inflow conduit of the Heat Flow Measurement Device, receiving a voltage from the thermoelectric material of the Heat Flow Measurement Device, converting this voltage to a digital word with an analog to digital converter, and correlating the digital word with a heat flow value.

The Heat Flow Measurement Device 1403, as previously described, produces a millivolt or microvolt signal that corresponds to incident flux. This signal is received by a heat meter 1405 that may simply display the output voltage on a scale that is meaningful to the end user. This display may be, for example, a liquid crystal display or a light emitting diode display with functionality analogous to a common digital voltmeter. The display may read in millivolts or microvolts and place the burden on the user to convert the voltage displayed to heat flow, or, in some embodiments of the present invention, the heat meter 1405 may contain the necessary lookup logic or display logic to convert the low level signal from the Heat Flow Measurement Device 1403 into an appropriate heat flow value. The heat meter may, in some embodiments of the present invention, contain temperature compensation circuitry as previously described. The heat meter 1405 may also, in some embodiments of the present invention, include digital functionality, operational amplifiers, analog to digital converters, lo pass filters, high pass filters, notch filters, and the like. Optionally, the heat meter 1405 may also produce a low level signal that corresponds to the low level signal of the Heat Flow Measurement Device 1403 and sends that signal to an analog to digital converter 1407 that in turn converts the low level signal into a binary word, digital word, or similar digital construct. With a binary word that corresponds to a heat flow value, a microcontroller or microprocessor 1409 is able to further process (1411) this data into a useful and tangible result. Said data may be stored in computer readable media for subsequent processing, downstream processing, transfer to other computer systems, and the like. Many applications can then be developed for such a digital value for heat flow in a system. Service 1413 can be scheduled, flagged, or communicated to another host computer or to a user output if heat flow values go outside of parameters specified in the processing logic. Control functionality 1415 may also be established when certain heat flow values are met. For example, fans or pumps may be activated or inactivated dependent on heat flow values to ensure meeting optimal functionality of the system upon which the Heat Flow Measurement Device is installed. Other functionality 1417 may be as simple as sending notifications of heat flow variations or thresholds to a handheld device by way of text messaging, email, or the like, or as complicated as using the provided heat flow values in a large industrial process control arrangement. The performance of a system such as a geothermal energy system can also be characterized and monitored to provide optimized system performance and related energy output. Heat flow values may also be used in finance applications 1419 such as allocating costs amongst shared tenants of a system or sending the values to an accounting system 1421 for applications such as billing 1423 or the like. An example of such functionality is described in U.S. Pat. No. 8,346,679 to Baller and entitled “Modular Geothermal Measurement System”, the entire disclosure of which is incorporated herein by reference. Other examples include solar thermal and district heating applications. In some embodiments, for example a geothermal energy system, the fluid flow in the outflow conduit of the Heat Flow Measurement Device is in fluid communication with the fluid flow in the inflow conduit. This arrangement may be, for example, a loop where heat energy is either picked up as fluid travels through the loop or released as fluid travels through the loop. The use of the Heat Flow Measurement Device is not limited to such a system, but rather, a closed system such as this is but one example of the many uses for the Heat Flow Measurement Device of the present invention.

It is, therefore, apparent that there has been provided, in accordance with the various objects of the present invention, a Heat Flow Measurement Device and Method. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and the attached drawings.

What is claimed is:

1. A heat flow measurement device comprising:
an outflow conduit having a first outflow conduit fitting and a second outflow conduit fitting;
an outflow fluid space within the outflow conduit;
an inflow conduit having a first inflow conduit fitting and a second inflow conduit fitting;
the inflow conduit generally encompassing the outflow conduit and an inflow fluid space created by the spacing between the inflow conduit and the outflow conduit;
an inflow heat transfer surface thermally coupled to a surface of the inflow conduit and an outflow heat transfer surface thermally coupled to a surface of the outflow conduit;
a thermoelectric material having an inflow heat transfer side and an outflow heat transfer side, the thermoelectric material located between the inflow heat transfer surface and the outflow heat transfer surface;
an inflow ohmic connection ohmically connected to the inflow heat transfer side of the thermoelectric material; and
an outflow ohmic connection ohmically connected to the outflow heat transfer side of the thermoelectric material.

2. The heat flow measurement device of claim 1, wherein the outflow conduit is generally cylindrical.

3. The heat flow measurement device of claim 1, wherein the inflow conduit is generally cylindrical.

4. The heat flow measurement device of claim 1, wherein the outflow conduit is generally rectangular.

5. The heat flow measurement device of claim 1, wherein the inflow conduit is generally rectangular.

6. The heat flow measurement device of claim 1, wherein the outflow conduit is generally triangular.

7. The heat flow measurement device of claim 1, wherein the inflow conduit is generally triangular.

8. The heat flow measurement device of claim 1, wherein the inflow conduit is generally coaxial with the outflow conduit.

9. The heat flow measurement device of claim 1, further comprising a plurality of flow veins located in the outflow fluid space of the outflow conduit.

10. The heat flow measurement Device of claim 1, further comprising a textured surface located in the outflow fluid space of the outflow conduit.

11. The heat flow Measurement Device of claim 1, further comprising a conductive layer located between the inflow heat transfer surface and the thermoelectric material.

12. The heat flow measurement device of claim 1, further comprising a conductive layer located between the outflow heat transfer surface and the thermoelectric material.

13. The heat flow measurement device of claim 1, wherein the thermoelectric material comprises a seebeck effect junction.

14. The heat flow measurement device of claim 1, further comprising a heat meter electrically connected to the first electrical contact and the second electrical contact.

15. A method of determining heat transfer in a load comprising the steps of:
creating a fluid flow in an outflow conduit having a first temperature and a second temperature;
creating a fluid flow in an inflow conduit having a third temperature;
receiving a voltage from a thermoelectric material in thermal communication with the fluid flow in the outflow conduit and the fluid flow in the inflow conduit;
subtracting the third temperature from the second temperature and dividing the result by the second temperature subtracted from the first temperature to yield the resulting heat flow in a load.

16. The method of claim 15, further comprising the steps of:
converting said voltage to a digital word with an analog to digital converter; and
correlating said digital word with a heat flux value.

17. The method of claim 15, wherein the fluid flow in the outflow conduit is in fluid communication with the fluid flow in the inflow conduit.

18. The method of claim 15, further comprising the step of storing said heat flux value on computer readable media.

19. The method of claim 18, further comprising the step of transferring said heat flow value stored on computer readable media to a billing system computer.

20. The method of claim 18, further comprising the step of transferring said heat flow value stored on computer readable media to a finance system computer.

21. A heat flow measurement device comprising:
an outflow conduit having a first outflow conduit fitting and a second outflow conduit fitting;
an outflow fluid space within the outflow conduit;
an inflow conduit having a first inflow conduit fitting and a second inflow conduit fitting;
an inflow fluid space within the inflow conduit;
an inflow heat transfer surface thermally coupled to a surface of the inflow conduit;
an outflow heat transfer surface thermally coupled to a surface of the outflow conduit;
a thermoelectric material having an inflow heat transfer side and an outflow heat transfer side, the thermoelectric material located between the inflow heat transfer surface and the outflow heat transfer surface;
an inflow ohmic connection ohmically connected to the inflow heat transfer side of the thermoelectric material; and
an outflow ohmic connection ohmically connected to the outflow heat transfer side of the thermoelectric material.
